(19) United States
(12) Patent Application Publication
(10) Pub. No.: US 2021/0094848 A1
(43) Pub. Date: Apr. 1, 2021

(54) LOW REACTIVITY CALCIUM HYPOCHLORITE SHAPED ARTICLE

(71) Applicant: INNOVATIVE WATER CARE, LLC, Alpharetta, GA (US)

(72) Inventors: Deqing Lei, Alpharetta, GA (US); Nidhi Rawat, Alpharetta, GA (US); Karllee Barton, Charleston, TN (US)

(21) Appl. No.: 17/062,745

(22) Filed: Oct. 5, 2020

Related U.S. Application Data
(63) Continuation of application No. 15/875,483, filed on Jan. 19, 2018, now abandoned.
(60) Provisional application No. 62/448,553, filed on Jan. 20, 2017.

(51) Int. Cl. C02F 1/50; A01N 25/34; A01N 59/06; C01B 11/06; C02F 1/76; A01N 59/00; C02F 1/68

(52) U.S. Cl. CPC C02F 1/50; A01N 25/34; A01N 59/06; C01B 11/068; C02F 2103/42; C01B 11/064; A01N 59/00; C02F 1/688; C02F 2303/04; C02F 1/76

(57) ABSTRACT

It has now been discovered that a shaped article containing calcium hypochlorite has low reactivity in handling, storage and transportation as well as has a favorable dissolution (solubility) profile, when the shaped article contains lime and a hydrated magnesium sulfate. The shaped article has a NFPA rating of Class 1 oxidizer and is a non-Division 5.1 oxidizer.

### CROSS REFERENCE TO RELATED APPLICATION

The present application is based on and claims priority to U.S. Provisional Patent Application Ser. No. 62/448,553, which was filed on Jan. 20, 2017, and which is incorporated herein by reference.

### FIELD OF INVENTION

The present invention relates to a calcium hypochlorite containing shaped article that has low reactivity in handling, storage and transportation and has a favorable dissolution (solubility) profile.

### BACKGROUND OF THE INVENTION

Calcium hypochlorite is known for use as a disinfecting treatment for water. Calcium hypochlorite has been used as a disinfectant for potable water, recreational water including, but not limited to, pools, spas, hot tubs, and the like, and industrial water, such as cooling towers and water used in the production of products. Calcium hypochlorite serves as a source of chlorine, which acts as a disinfectant to keep water free of water-borne pathogens and other organisms such as algae. Examples of calcium hypochlorite compositions, including tablets are found in, for example U.S. Pat. Nos. 3,793,216; 4,201,756; 4,145,306; 4,692,335; 5,164,109; and 5,753,602. In particular, U.S. Pat. Nos. 6,638,446 and 6,984,398 disclose compositions for treatment of recreational water that comprise mixtures of calcium hypochlorite and magnesium sulfate heptahydrate. U.S. Pat. No. 6,969,527 discloses compositions for treatment of recreational water that comprise mixtures of calcium hypochlorite, magnesium sulfate heptahydrate, and lime.

Calcium hypochlorite is a strong oxidizer and as such can cause a severe increase in the burning rate of combustible material with which it comes in contact. This oxidation characteristic can cause problems both in the transport and storage of the product. For example, fires involving calcium hypochlorite can be quite vigorous, particularly when combustible material is present, including the product's packaging material itself (e.g., plastic, cardboard).

Classification of oxidizers is given by the National Fire Protection Association (NFPA). In NFPA 400, Hazardous Materials Code (2016 Edition), Annex G, the definition of an oxidizer is given as any material that readily yields oxygen or other oxidizing gas, or that readily reacts to promote or initiate combustion of combustible materials and can undergo a vigorous self-sustained decomposition due to contamination or heat exposure. Oxidizers are further broken down according to the degree to which they increase the burning rate of combustible materials as follows:

Class 1: An oxidizer that does not moderately increase the burning rate of combustible materials with which it comes into contact.

Class 2: An oxidizer that causes a moderate increase in the burning rate of combustible materials with which it comes into contact.

Class 3: An oxidizer that causes a severe increase in the burning rate of combustible materials with which it comes into contact.

Class 4: An oxidizer that can undergo an explosive reaction due to contamination or exposure to thermal or physical shock and that causes a severe increase in the burning rate of combustible materials with which it comes into contact.

Calcium hypochlorite is a Class 3 oxidizer according to the NFPA oxidizer classification system. Currently, there are no high available chlorine content calcium hypochlorite shaped articles on the market which have an NFPA class 1 rating and a non-Division 5.1 oxidizer rating.

Efforts have been made to produce hydrated calcium hypochlorite containing products that are not classified as a “Division-5.1 oxidizer” as measured by an internationally recognized standard, i.e. the United Nations Protocol: Transport of Dangerous Good: Manual of Tests and Criteria, Section 34; Classification Procedures, Test Methods, and Criteria relating to Oxidizing Substances of Division 5.1. U.S. Pat. No. 6,638,446, assigned to Arch Chemicals, describes a non-Division-5.1 calcium hypochlorite composition consisting of a blend of hydrated calcium hypochlorite and magnesium sulfate heptahydrate. In this invention, the blend comprising of 70 parts of 68% calcium hypochlorite and 30 parts of magnesium sulfate heptahydrate by total weight of the blend, in which the blend contains at least 17% of total water, and 47% available chlorine, is commercially classified as a non-Division-5.1 Oxidizer. Similarly, U.S. Pat. No. 6,969,527, assigned to Arch Chemicals, discloses a non-Division 5.1 oxidizer tablet having the similar composition of hydrated calcium hypochlorite and magnesium sulfate heptahydrate with the addition of lime. Although these patents discuss the reduced reactivity of the blends, neither U.S. Pat. No. 6,638,446 nor 6,969,527, describes a composition containing calcium hypochlorite, having high available chlorine content, will exhibit a NFPA Class 1 rating. Further, it is suggest that the lime content be less than 10% by weight.

NFPA class 1 ratings in calcium hypochlorite compositions has been obtained by coating the calcium hypochlorite with layers of material non-reactive with the calcium hypochlorite, and in particular coating the calcium hypochlorite with salts, such as sodium chloride and hydrated magnesium sulfate, as is described in U.S. Pat. No. 8,252,200, assigned to Arch Chemicals. By coating the calcium hypochlorite and NFPA class 1 or class 2 rating may be obtained, as is disclosed, and is further classified as a non-Division 5.1 oxidizer as well. While the coated calcium hypochlorite is effective for obtaining the desired ratings, the cost of preparing coated calcium hypochlorite makes the product too expensive with currently available technology.

In a recently published patent application US Published Patent Application 2016/0330972, assigned to Arch Chemicals, it is disclosed that forming a shaped article from a composition containing a blend containing calcium hypochlorite and greater than 10% lime, based on the total weight of the shaped article, the dissolution rate of the shaped article can be matched to that of trichloroisocyanuric acid. Matching the dissolution rate of a calcium hypochlorite article to trichloroisocyanuric acid provides a distinct advantage since no cyanuric acid by-product is being released to the water being treated. As known in the art, when the content of cyanuric acid exceeds certain limits, for example 100 ppm, the chlorine in the pool or spa becomes ineffective. It is generally preferable that the cyanuric acid content of pool and spa water is kept well below 100 ppm, for example less than 80 ppm and more preferably less than 50 ppm and even more preferably less than 30 ppm. Some cyanuric content is beneficial to the chlorine in the pool or spa since it acts as a stabilizer for the chlorine in the water. Further, it has been discovered that the shaped article from the blend containing calcium hypochlorite and greater than 10% lime, based on the total weight of the shaped article, will also maintain its structural integrity during dissolution in the use environment. That is, the shaped article will generally have the same shape, but reduces its size during dissolution and does not become soft or brittle during dissolution.

Calcium hypochlorite is known to quickly dissolve in water, especially in the granular form. It is often used as a pool shock, to increase the chlorine content in the pool. Attempts have been made in the art to slow the rate of dissolution of calcium hypochlorite in water, as is shown in U.S. Pat. Nos. 4,876,003 and 4,928,813 both issued to Casberg. Plastic sleeves were positioned around the tablet to slow down the dissolving rate of calcium hypochlorite tablets. When placed around the tablets, the tablets last longer, thus providing convenience in chlorinating swimming pools and other applications. However, such plastic sleeves, after use, must be removed from the skimmers, feeders and floaters for the swimming pools where they were used. This removal and discarding can be inconvenient to the pool owner. Alternatively, finely divided polyfluorinated polymer has been added to calcium hypochlorite tablets to cause the tablets to dissolve slower. See U.S. Pat. Nos. 4,865,760; 4,970,020; 5,009,806; and 5,205,961.

Conventionally, it has been suggested in the calcium hypochlorite art to use up to 10% by weight lime in calcium hypochlorite blends, which are to be tableted. While it is recognized that lime may extend the chlorine delivery time of a tablet containing calcium hypochlorite into an aqueous environment, there is no suggestion in the art to blend more than 10% lime with calcium hypochlorite.

There is a need in the art for a water sanitizing composition from calcium hypochlorite which can be classified as NFPA class 1 oxidizer, that does not require coating the calcium hypochlorite and is cost effective. There is a need in the art for a water sanitizing composition, which has the favorable dissolution (solubility) profile of trichloroisocyanuric acid, without the disadvantage of a cyanuric acid by product being released in the water being treated, which also exhibits a NFPA class 1 oxidizer rating and a non-Division 5.1 DOT oxidizer rating. The present invention provides an answer to that need.

### SUMMARY OF THE INVENTION

In one aspect, the present invention provides a shaped article containing (i) calcium hypochlorite, (ii) lime in an amount greater than 10% by weight, based on the total weight of the shaped article, and (iii) hydrated magnesium sulfate can be formed into a solid shaped article, wherein the solid shaped article has a NFPA class 1 oxidizer rating, a non-Division 5.1 oxidizer rating and which has a favorable dissolution (solubility) profile. In another aspect, the calcium hypochlorite particles used for the shaped article are uncoated.

In one embodiment of the invention, the shaped article may be formed into a unitary structure prepared from a blend of the calcium hypochlorite, the lime, and the hydrated magnesium sulfate.

In another embodiment of the invention, the shaped article has a layered structure. In the layered structure, there is a first layer and a second layer, where the first layer and the second layer each have a first surface and an opposite second surface. The first surface of the first layer is in contact with the first surface of the second layer. In this embodiment, the first layer contains a blend of the calcium hypochlorite and the lime; and the second layer contains the hydrated magnesium sulfate. In a further aspect of this embodiment, there may be a third layer. This third layer has a first surface, wherein the first surface of the third layer is in contact the second surface of the first layer, such that the first layer is between the second and third layers. In the layered structure, the outer edge of the first layer may or may not be covered with the hydrated magnesium sulfate. When covered with the hydrated magnesium sulfate, the magnesium sulfate may encase the first layer.

In another aspect, the calcium hypochlorite of the shaped article may have an available chlorine content which is greater than 70% by weight. In a particular embodiment, the available chlorine is between about 75% by weight and 85% by weight.

In a further embodiment, the hydrated magnesium sulfate comprises magnesium sulfate tetrahydrate, magnesium sulfate pentahydrate, magnesium sulfate hexahydrate, magnesium sulfate heptahydrate or a combination thereof.

In an additional embodiment, the calcium hypochlorite of the shaped article is hydrated.

In a further aspect of the invention, the shaped article contains the magnesium sulfate hydrate in an amount between 15% and up to 40% by weight of the shaped article and the calcium hypochlorite is at least 50% by weight of the shaped article and the lime is present in an amount greater than 10% by weight up to about 20% by weight of the shaped article. In a particular embodiment, the hydrated magnesium sulfate comprises between 20% and up to 35% by weight of the shaped article and the calcium hypochlorite comprises at least 55 and about 70% by weight of the shaped article and the lime is present in an amount greater than 10% by weight up to about 16% by weight of the shaped article.

In an additional aspect of the present invention, the water content of the blend forming the shaped article is at least 18% by weight. In a particular embodiment, the water content of the shaped article is between 18% and 28% by weight, more typically between 18% and 24% by weight.

In yet another embodiment, the shaped article can further contain an additive. Exemplary additives include a water-soluble zinc salt, a hydrate of zinc salt, a scale inhibiting agent, a pigment, a dye, a binder, a lubricant, a color-containing salt, or a mixture of two or more of these additives.

In a particular embodiment, the shaped article is formed from a blend of the calcium hypochlorite, the lime, and the hydrated magnesium sulfate, where (i) the calcium hypochlorite is hydrated and has an available chlorine content between about 75% by weight and 85% by weight, (ii) the hydrated magnesium sulfate contains magnesium sulfate tetrahydrate, magnesium sulfate pentahydrate, magnesium sulfate hexahydrate, magnesium sulfate heptahydrate or a combination thereof, and (iii) the water content of the shaped article is between 18% and 28% by weight. In a further embodiment, the hydrated magnesium sulfate is between 20% and up to 35% by weight of the shaped article and the calcium hypochlorite comprises at least 55 and about 70% by weight of the shaped article and the lime is present in an amount greater than 10% by weight up to about 16% by weight of the shaped article.

In another aspect, the shaped article is in the form of tablets, bricks, briquettes, pellets, or an extrusion. The shaped article may have a total weight between 1 and 500 grams. Also, the shaped article has a slow dissolution rate such that the shaped article (e.g., a tablet) dissolves in a range of 3 to 14 days.

Also provided is a method of treating water. The method includes providing the shaped article according to any one the embodiments of the invention and contacting the water to be treated with the shaped article. The water to be treated may be a pool or a spa.

Further provided is a method for disinfecting or sanitizing water. The method includes providing the shaped article according to any one the embodiment of the invention and contacting the water to be disinfected or treated with the shaped article.

In a further embodiment of disinfecting or sanitizing water, the water to be treated is contacted with the shaped article by placing the shaped article in a skimmer of a swimming pool.

In another embodiment of disinfecting or sanitizing water, the water to be treated is contacted with the shaped article by placing the shaped article in a chlorine feeder and the water to be treated is contacted with the shaped article within the chlorine feeder.

In yet another embodiment of disinfecting or sanitizing water, the water to be treated is contacted with the shaped article by placing the shaped article in a floater which floats in the water to be treated, and water enters the floater to contact the shaped article.

These and other aspects will become apparent when reading the detailed description of the invention.

### BRIEF DESCRIPTION OF DRAWINGS

FIG. 1 shows a representative unitary shaped article.

FIG. 2 shows a representative two-layer shaped article.

FIG. 3 shows a three-layer shaped article.

FIG. 4 shows an encased shaped article.

### DETAILED DESCRIPTION OF THE INVENTION

It has now been surprisingly found that a shaped article containing (i) calcium hypochlorite, (ii) lime in an amount greater than 10% by weight, based on the total weight of the shaped article, and (iii) hydrated magnesium sulfate can be formed into a solid shaped article, wherein the solid shaped article has a NFPA class 1 oxidizer rating, a non-Division 5.1 oxidizer rating and which has a favorable dissolution (solubility) profile. In addition, it has been surprisingly discovered that the solid shaped article made from the composition maintains its structural integrity during use in an aqueous environment.

The term “blend”, as used herein, refers to any homogeneous or near homogeneous mixture of two or more materials. It does not include encapsulated or layered products. An example of an encapsulated material would be calcium hypochlorite particles that are coated.

The term “hydrated” as used in conjunction with the composition of the present invention, or components thereof, refers to any substance that has a water content of at least 4% by weight. Similarly, the term “hydrate” as used in the context of a particular substance, refers to waters of hydration.

The term “shaped article” as used in the present specification and claims is intended to cover any shape or size article which is compressed from the blend containing calcium hypochlorite, lime and hydrated magnesium sulfate. Alternatively, the term “shaped article” also means an article which has layers of the individual ingredients or layers of blends of ingredients which are compressed together to form a unitary structure. As used herein, the term “shaped article” does not cover loose granular materials. Typically shaped articles will include tablets, bricks, briquettes, pellets, extrusions and the like, in any shape or size. Tablets will generally be disc shaped or cylindrical in shape, but could have other shapes as well.

The term “maintains its structural integrity” as used herein, is intended to mean the ability of the shaped article to remain intact, essentially retaining its general shape and hardness in the use environment. A shaped article that becomes brittle, soft or disintegrates during use is not considered to maintain its structural integrity. A shaped article that remains hard, and retains its overall structure during use, but reduces its size due to dissolution is considered to maintain its structural integrity.

The term “NFPA class 1 oxidizer rating” means that the composition passes the NFPA testing protocol as outlined in NFPA 400, Hazardous Materials Code (2016 Edition), Annex G.

The term “non-Division 5.1 oxidizer” means that the composition is not rated as a “Division 5.1 oxidizer” as measured by an internationally recognized standard, i.e. the United Nations Protocol: Transport of Dangerous Good: Manual of Tests and Criteria, Section 34; Classification Procedures, Test Methods, and Criteria relating to Oxidizing Substances of Division 5.1.

The calcium hypochlorite used in the shaped article is generally a calcium hypochlorite composition and may be either anhydrous or hydrated. Generally, the calcium hypochlorite compositions used in the shaped article has high available chlorine content, meaning the available chlorine content is greater than 65%. Available chlorine content is essentially equivalent weight percentage of the Ca(OCl)₂ in the calcium hypochlorite composition. Typically, the calcium hypochlorite composition have an available chlorine content of greater than 70% and will more typically have an available chlorine content in the range of 75% to 85%. Hydrated calcium hypochlorite composition will generally have a hydrated water content ranging from about 4 to about 25% by weight, based on the weight of the calcium hypochlorite. Hydrated calcium hypochlorite composition can be prepared by the methods described, in U.S. Pat. Nos. 3,544,267 and 3,669,984, both of which incorporated by reference in their entireties. Commercially available hydrated calcium hypochlorite composition is available from Arch Chemicals, Inc. having offices in Alpharetta, Ga. under the commercial names SUPER SHOCK®, and RAPID RATE® pool chemical brand name. Commercially available calcium hypochlorite compositions generally include 5 to 16% by weight water of hydration. Generally, commercially available calcium hypochlorite compositions contain 50-95% by weight calcium hypochlorite and other components, other than water of hydration, such as salts (sodium chloride, calcium chloride, calcium carbonate, lime and the like) in amounts up to 20% by weight. However, it is desirable to keep these other components to a minimum. The process used to make a calcium hypochlorite may also result in lime being present in the calcium hypochlorite in amounts up to about 2-4% by weight, based on the weight of the calcium hypochlorite composition.

In the shaped article, the calcium hypochlorite composition is generally at least 50% by weight of the shaped article. Typically, the calcium hypochlorite is present in an amount of at least 55% by weight, and more typically between about 55% to about 70% by weight. Depending on the end use, the amount of the calcium hypochlorite may be less than 50, in particular if other additives, discussed below, are present in the composition.

The shaped article will also contain lime. Generally, the lime is blended with the calcium hypochlorite or calcium hypochlorite composition. Lime may be calcium oxide or calcium hydroxide. Lime in the present invention is preferably the inactive form calcium hydroxide (Ca(OH)₂). Generally, the lime is blended with the calcium hypochlorite in an amount such that the resulting blend will contain greater than 10% by weight, based on the total weight of the shaped article. As is noted above, lime may also be present in calcium hypochlorite compositions in amounts of about 2-4% by weight, depending on the manufacturing process used to manufacture the calcium hypochlorite. In any event, if lime is present in the calcium hypochlorite composition used to make the shaped article, the lime content of the calcium hypochlorite composition is accounted for the total lime content in the shaped article. For example, if the calcium hypochlorite contains 3% by weight lime, and 10% by weight lime is added to the calcium hypochlorite, the resulting blend will contain 12.7% by weight lime. (90%×3% (lime in Ca(OCl)₂)+10% lime=12.7%).

The total content of lime in the shaped article is an amount greater than 10% by weight, generally in an amount greater than or equal to 11% by weight, greater than or equal to 12% by weight, greater than or equal to 13% by weight, greater than or equal to 14% by weight, or greater than or equal to 15% by weight based on the total weight of the shaped article. By “total lime content” it is meant added lime (lime added to the calcium hypochlorite composition) and any lime originally present in the calcium hypochlorite composition in which the added lime is blended. Lime in this amount will result in a shaped article prepared in accordance with the present disclosure to have a favorable dissolution profile, which is similar to that of trichloroisocyanuric acid (trichlor), without the downside of generating too much cyanuric acid in the pool that will result from using trichloroisocyanuric acid, since cyanuric acid is a by-product. In addition, the resulting shaped article will have structural integrity. Generally, the shaped article will have a total lime content in the range in an amount between greater than 10% and 40% by weight of the total weight of the shaped article. Typically, the shaped article will contain lime in an amount between greater than 10% and 20% by weight of the total weight of the shaped article and more typically between greater than 10 and 16% by weight of the total weight of the shaped article.

The third component of the shaped article is a hydrated magnesium sulfate having the general formula of (MgSO₄.xH₂O), where x is the number of moles of hydrated water. Examples of hydrated forms include magnesium sulfate monohydrate (MgSO₄.H₂O), magnesium sulfate dihydrate (MgSO₄.2H₂O), magnesium sulfate trihydrate (MgSO₄.3H₂O), magnesium sulfate tetrahydrate (MgSO₄.4H₂O), magnesium sulfate pentahydrate (MgSO₄.5H₂O) and magnesium sulfate hexahydrate (MgSO₄.6H₂O), magnesium sulfate heptahydrate (MgSO₄.7H₂O) or mixtures thereof. Magnesium sulfate tetrahydrate, magnesium sulfate pentahydrate, heptahydrate is generally used hydrated magnesium sulfate, due to the high water content from the water of hydration.

In general, the amounts of the hydrated magnesium sulfate ranges from about 1 to about 50 weight present based on the weight of the shaped article. The amount of the magnesium sulfate is generally determined based on the amount of hydrated water in the calcium hypochlorite composition and the number of moles of hydration in the hydrated magnesium sulfate. The shaped article should have at least 16% water by weight. Typically, the water content of the shaped article should be at least 18% by weight and is often in the range of 18% to 30% by weight. More typically, the water content of the shaped article is in the range of 18% to 28% by weight. Most typically, a water content between 18% and 24% by weight is ideal for the balance of stability and chlorine content. The amount of water in the shaped articles may be calculated by any standard analytical method for measuring water in chemical products like these. One particular method is thermogravimetric analysis (TGA). Therefore, the amount of the hydrated magnesium sulfate is typically from about 15% about 40% by weight of the total weight of the shaped article. Most typically, the hydrated magnesium sulfate is most typically, present in the shaped article in an amount between about 20% to about 35% by weight, based on the total weight of the shaped article. It is noted that the lower the degree of hydration of the magnesium sulfate, the greater amount of the hydrated magnesium sulfate will need to be added. Typically magnesium sulfate tetrahydrate, magnesium sulfate pentahydrate, magnesium sulfate hexahyrate and/or magnesium sulfate heptahydrate are used for their great water content due to water of hydration. For example, a monohydrate will need to be present in a greater amount than a hydrate having more waters of hydration, since the monohydrate contains less water than, for example, heptahydrate.

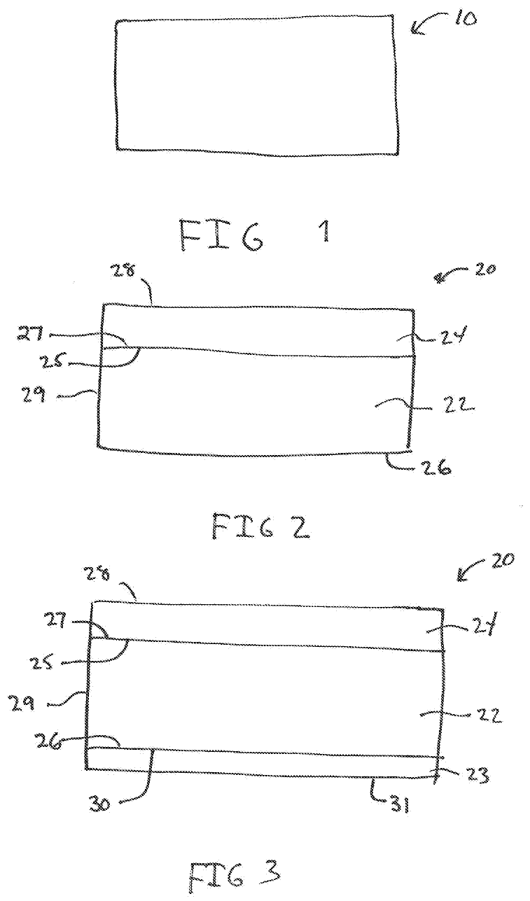

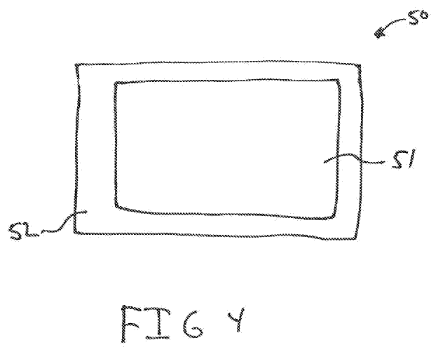

The shaped article of the present invention may be a unitary structure, a layered structure, or an encased structure. Referring to FIG. 1, shown is a unitary structure 10. In a unitary structure, the calcium hypochlorite, lime and the hydrated magnesium sulfate are all blended together and formed into the shaped article. Referring to FIGS. 2 and 3, shown is a layered structure 20 which has a first layer 22 and a second layer 24. The first layer 22 has a first surface 25 and an opposite second surface 26. The second layer 24 has a first surface 27 and a second surface 28. The first surface 25 of the first layer 22 is in contact with first surface 27 of the second layer 24. In FIG. 3, a third layer 23 having first surface 30, which is in contact with the second 26 of the first layer 22. In a further embodiment, the shaped structure may be an encased structure 50, shown in FIG. 4. In the encased structure, an inner body 51 is surrounded by an outer layer 52.

In the layered structures shown in FIGS. 2 and 3, the first layer 22 will generally contain a blend of the calcium hypochlorite and the lime. Optionally, the first layer 22 may also contain the hydrated magnesium sulfate. The second layer 24 and third layer 23 will contain the hydrated magnesium sulfate. Generally, the second layer and the third layer will not contain the calcium hypochlorite or the lime. In FIG. 4, the inner body 51 will generally contain a blend of the calcium hypochlorite and the lime. Optionally, the inner body 51 may also contain the hydrated magnesium sulfate. The outer layer 52 will contain the hydrated magnesium sulfate. Generally, the outer layer 52 will not contain the calcium hypochlorite or the lime. In these configurations, when contacted with water, the hydrated magnesium layers will quickly dissolve leaving the first layer 22 or the inner body 51 containing the calcium hypochlorite and lime blend, which will dissolve slowly. The first layer has an outer edge 29 not covered by another material, in particular the hydrated magnesium sulfate.

Depending on the configuration of the shaped articles, different processes are used to form the shaped articles. In the case of a unitary structure, such as that shown in FIG. 1, the shaped articles are formed from the blend of calcium hypochlorite, lime and hydrated magnesium sulfate and may be prepared from granular blend of calcium hypochlorite, lime and hydrated magnesium sulfate. The calcium hypochlorite, lime, and hydrated magnesium sulfate are blended using any known techniques. For example, tumble blenders, V-blenders, ribbon blenders and the like may be used in a batch mode to blend the composition of the calcium hypochlorite and lime. Additionally, screw augurs, conveyers, and the like may be used in a continuous mode to blend the composition. Other mixing methods can be used, but it has been found that dry blending of free flowing granules or powders of lime, hydrated magnesium sulfate and calcium hypochlorite yields shaped articles with improved integrity and dissolution profiles. An alternative method is to blend lime and hydrated magnesium sulfate with the calcium hypochlorite, where the calcium hypochlorite, hydrated magnesium sulfate and lime are in a wet state, and drying the resulting mixture.

Once the blend of the calcium hypochlorite, hydrated magnesium sulfate and lime is made, any conventional tableting process and equipment normally used for making calcium hypochlorite containing shaped articles may be used to manufacture the shaped articles of the present invention. Any suitable equipment that produces molded compacted products such as tablets, caplets or briquettes, or other known molded compacted products, using the blends of the present invention may be used. Any shape or size shaped article may be used. Preferred shaping equipment includes hydraulic tableting presses (such as Hydratron or Hydramet or Bipel hydraulic presses), briquetting apparatus (such as a Bepex Compactor), and the like. Any suitable dwell times and pressures may be used in operating such hydraulic presses. Specifically, these shaped articles are useful as water treatment sanitizers (e.g. in swimming pools and spas), and are especially safer to transport and store than calcium hypochlorite itself.

In the case of the layered products, where one of the layers contains a blend of calcium hypochlorite and lime, these two components are blended together using the same techniques as the three components. In forming a layered tablet, generally one of the layers of material is first placed in the die of the tableting press with the other layer or layer added after and all of the layers are pressed together, using known techniques.

In addition to calcium hypochlorite, hydrated magnesium sulfate and lime, other additives in amounts up to about 20% by weight of the shaped article may be blended with the calcium hypochlorite and lime. These additives are optional, but may be added to impart other properties to the resulting shaped article. Examples include water-soluble zinc salts or hydrates of zinc salts as an algaecide as described in U.S. Pat. No. 8,372,291 to Mullins et al., hereby incorporated by reference in its entirety; scale inhibiting agents such as alkali metal phosphates and residue dispersing alkali metal phosphate combinations as described in U.S. Pat. No. 7,410,938 to Brennen; hereby incorporated by reference in its entirety. Zinc salts are typically added in amounts up to about 10% by weight of the shaped article. Scale inhibitors are typically added in amounts up to about 5% by weight of the shaped article. Other additives include coloring agents such as pigments, dyes or color-containing salts, binders, lubricants, and the like. Coloring agents that may be used in the shaped article, but are not limited to, ultramarine blue, phthalocyanine blue, and phthalocyanine green. Generally, the concentration of the coloring agent is between 0.01 and 0.5%, based on the weight of the shaped article. Suitable binders include, for example boric acid and its metallic salts, magnesium aluminum silicates, polymeric acid salt, zeolites, sodium silicate, alumina silicate, bentonite, bitumen, calcium aluminate, gilsonite, lignosulfonate and mixtures thereof. Binders may be present in an amount up to about 10% by weight, more typically up to about 5% by weight. These additives may be pre-blended with the calcium hypochlorite, hydrated and/or lime, or may be added as a separate solid in the blending process. Care should be taken, since some additives will increase the dissolution rate of the shaped article or to remove the NFPA class 1 rating.

In general, the shaped article, which is placed in the skimmer of a swimming pool that recirculates the water 8 hours per day at a conventional flow rate, will typically contain between a total lime content of about 11 to 20% by weight. The actual amount of lime in the used in the shaped article will depend on the planned end use of the shaped article. Increasing the amount of lime in the shaped article will generally increase the time that shaped article will release chlorine to treat the aqueous environment.

It has been further discovered that the shaped article made from the blend of calcium hypochlorite, hydrated magnesium sulfate and lime, where the lime is present in an amount greater than 10% by weight of the shaped article, will result in a shaped article that will maintain its integrity during use, while in an aqueous environment of either stagnant or circulating water. That is, the shaped articles do not crack or do not become structurally unstable. By “structurally unstable” it is meant shaped article will become soft, “mushy”, forms crack or fissures, or breakup during use. When a shaped article cracks, or loses the integrity, the surface area of the shaped article will increase, thereby causing the shaped article to dissolve a faster rate. It is further believed that these blended shaped articles are more stable with the inclusion of lime in an amount greater than 10% by weight of the blend, also resulting in an extended shelf life of the shaped articles.

When the shaped article is a layered structure, with the hydrated magnesium sulfate forming substantially all or predominately one of the layers, the magnesium sulfate will tend to rapidly dissolve leaving the layer containing the blend of the calcium hypochlorite and lime. Once in the use environment, the hydrated magnesium sulfate is not needed since the shaped article is no longer a fire hazard as an oxidizer. Therefore, the rapid dissolution of the hydrated magnesium sulfate layer does not present a concern for the other layer, in particular the layer of the calcium hypochlorite and lime of the shaped article. The layer of the calcium hypochlorite and lime will have the desired dissolution profile.

The shaped articles made in accordance with the present invention may be used in a wide variety of uses, including a chlorine source for spas, swimming pools, hot tubs, toilets and other similar uses where chlorine is needed to sanitize water sources. The shaped article can be added directly to a chlorination unit or feeder that is attached to the body of water that is sought to be chlorinated. When used in such a manner, the shaped article dissolves and is dispersed into the body of water when it is contacted with a stream of water. Alternatively, the shaped articles composition may be used in skimmers or in a floating device (known as a ‘floater’) or feeders such as those used for feeding chlorinated isocyanurates to swimming pools and spas.

The shaped articles useful in this invention may typically have a mass of between about 1 gram and about 500 grams or more, typically between about 7 and 350 grams and more typically between 150 and 300 grams. The actual size of the shaped articles can be adjusted depending on the intended us of the resulting shaped articles. In one embodiment, the shaped article will be in the form of a compressed tablet. The compressed tablet may be of a size which may be inserted readily into a skimmer or dissolving basket used with swimming pools or dissolvers used to form concentrated solutions of calcium hypochlorite. The shaped articles of the present invention are typically designed to dissolve in 3 to 14 days, more typically 3-7 days, when used in swimming pools, spas and the like, but can be designed to dissolve in 28-35 day, in the case of a toilet sanitizer. It should be keep in mind that various factors affect the dissolution rate of the shaped articles, including flow rate of water over the shaped article, temperature of the water and the like. The dissolution rate may be adjusted by the amount of lime added to the calcium hypochlorite. An exemplary shape for the shaped articles of the present invention is a puck-shaped article, having a diameter between 1 to 4 inches and a thickness between 1 and 2 inches. Larger or smaller shaped articles may be used as well.

Surprising, it has been discovered that the compositions of the shaped articles of the present invention can pass NFPA class 1, as measure in accordance with NFPA 400, Hazardous Materials Code (2016 Edition), Annex G. Prior to the present invention, tablets containing calcium hypochlorite with high available chlorine content were unable to achieve an NFPA class 1 rating. In addition, the composition of the shaped articles of the present invention were also found to be a non-DOT 5.1 oxidizer measured in accordance with the UN O.3 method may be found in the Recommendations on the Transport of Dangerous Goods, Manual of Tests and Criteria, Sixth Revised Edition, United Nations, 2015 (ST/SG/AC.10/11/Rev.6), 34.4.3 Test O.3: Gravimetric test for oxidizing solids.

The present invention is further described in detail by means of the following Examples. All parts and percentages are by weight and all temperatures are degrees Celsius unless explicitly stated otherwise.

### EXAMPLES

### Example 1

A commercially available calcium hypochlorite composition available from Arch Chemicals, Inc., having offices in Alpharetta, Ga., is dry blended with calcium hydroxide powder (lime) and magnesium sulfate heptahydrate in a V-blender for a period of time to form a homogenous mixture in amounts shown in Table 1. The calcium hypochlorite composition contained about 3% calcium hydroxide (lime). After mixing, each of the blends was formed into 100 g tablet having a diameter of about 2 inch (5.1 cm), using a Carver Table Press model 3890 using 16-20 ton force with a 15 second dwell time. The total available chlorine for each tablet is about 50%.

TABLE 1
Lab production of prototype 100 g - 2 inch tablet formulations

| Chemical | | | Sample | Sample | Sample |
|---|---|---|---|---|---|
| name | Trade Name | Supplier | A | B | C |
| Calcium | HTH 75 | Arch Chemicals, Inc., | 68.0 | 67.0 | 68.0 |
| Hypochlorite | Superchlorinator | 5660 New Northside | | | |
| | shock | Drive, Suite 1100, | | | |
| | | Atlanta, GA 30328 | | | |
| Calcium | Hydrated lime | Mississippi Lime Company, | 10.0 | 11.0 | 9.0 |
| hydroxide | | HYWAY 61 S, Ste | | | |
| | | Genevieve, MO 63670, USA | | | |
| | | Total Lime content | 13% | 14% | 12% |
| Magnesium | Magriculture ® | Giles | 22.0 | 22.0 | 23.0 |
| sulfate | | P. O. Box 370 | | | |
| heptahydrate | | Waynesville, NC 28786 | | | |
| Total | | | 100.0% | 100.0% | 100.0% |

Tablets prepared above were tested for dissolution properties by being placed in a skimmer of a 5000-gallon pool and the pump was run for 8 hours per day. The tablets were monitored daily and were removed from the skimmer and patted dry with a paper towel. The tablets were weighed each day and the weights are shown in Table 2.

TABLE 2
Pool dissolution test results of 100 g - 2 inch tablets

| | Initial | wt. (g) | wt (g) | wt (g) | wt (g)² |
|---|---|---|---|---|---|
| Sample | wt. (g) | @Day 1 | @Day 2 | @Day 3 | @Day 4 |
| A | 100.2 | 70.57 | 29.90 | 14.71 | 5.9 |
| B | 101.7 | 76.86 | 35.97 | 16.29 | 2.9 |
| C | 100.4 | 55.63 | 19.76 | 4.98 | 0.4 |

As can be seen from the Table 2, the Samples A and B lasted 4 days, showing that the tablets had a slow dissolving dissolution profile. Sample C also lasted 4 days but the residual amount of the tablet showed that the tablet was essentially completely dissolved. It was determined that Samples A and B have the more desirable dissolution profile and the compositions were subjected to testing in accordance NFPA 400, Hazardous Materials Code (2016 Edition), Annex G. The results of the testing are shown in Table 3.

TABLE 3
Burning test results of the compositions

| | Max. burn rate (g/s) | | Burn time (s) | | |
|---|---|---|---|---|---|
| | Required | | Required | | NFPA |
| | For NFPA | Result | For NFPA | | class |
| Sample | Class 1 | (4:1 ratio) | Class 1 | result | rating |
| A | ≤0.3 | 0.16 ± 0.04 | ≥30 | 79 ± 20 | class 1 |
| B | ≤0.3 | 0.19 ± 0.02 | ≥30 | 68.8 ± 0.83 | Class 1 |

### Example 2

680 g commercially available calcium hypochlorite composition available from Arch Chemicals, Inc., having offices in Alpharetta, Ga., is dry blended with 100 g calcium hydroxide powder (lime) and 220 g magnesium sulfate heptahydrate in a V-blender for a period of time to form a homogenous mixture in amounts shown in Table 4. The calcium hypochlorite composition contained about 3% calcium hydroxide (lime). After mixing, the blend was formed into 250 g tablets having a diameter of about 2⅝ inch (6.7 cm), using a Baldwin press with a 70 Hz press rate. The resulting tablets had a density or about 1.65 g/ml

TABLE 4

| Chemical | | | Sample |
|---|---|---|---|
| name | Trade Name | Supplier | D |
| Calcium | HTH 75 | Arch Chemicals, Inc., | 68.0% |
| Hypochlorite | Superchlorinator | 5660 New Northside | |
| | shock (J3) | Drive, Suite 1100, | |
| | | Atlanta, GA 30328 | |
| Calcium | Hydrated lime | Mississippi Lime Company, | 10.0% |
| hydroxide | | HYWAY 61 S, Ste | |
| | | Genevieve, MO 63670, USA | |
| | | Total Lime content | 13% |
| Magnesium | Magriculture ® | Giles | 22.0% |
| sulfate | | P. O. Box 370 | |
| heptahydrate | | Waynesville, NC 28786 | |
| Total | | | 100.0% |

Tablets prepared above were tested for dissolution properties by being placed in a skimmer of a 5000-gallon pool and the pump was run for 8 hours per day. The tablets were monitored daily and were removed from the skimmer and patted dry with a paper towel. The tablets were weighed each day and the weights are shown in Table 5.

TABLE 5
Tablet weight over dissolution days in pool screening test

| | | Tablet | Tablet | Tablet | Tablet | Tablet | Tablet |
|---|---|---|---|---|---|---|---|
| | Pool | wt. (g) | wt. (g) | wt. (g) | wt. (g) | wt. (g) | Wt. (g) |
| Sample D | # | @Day 0 | @Day 1 | @Day 2 | @Day 3 | @Day 4 | @day 5 |
| Tablet 1 | 1 | 251.9 | 219.1 | 183.4 | 146.4 | 78.1 | done |
| Tablet 2 | 2 | 252.7 | 214.3 | 181.2 | 140.2 | 60.5 | done |

As can be seen from the Table 5, the tablets made in accordance with Example 2 lasted 4 days, showing that the tablets had a slow dissolving dissolution profile. The composition of Sample D has passed the test in accordance NFPA 400, Hazardous Materials Code (2016 Edition), Annex G, as is shown above and has a class 1 NFPA rating

### Comparative Example 1

Samples formed without hydrated magnesium sulfate but containing only calcium hypochlorite and lime with the same ratios of lime to calcium hypochlorite would fail to meet NFPA Class 1 rating.

While the invention has been described above with references to specific embodiments thereof, it is apparent that many changes, modifications and variations can be made without departing from the invention concept disclosed herein. Accordingly, it is intended to embrace all such changes, modifications, and variations that fall within the spirit and broad scope of the appended claims.

1-27. (canceled)

28. A shaped article comprising:
(i) calcium hypochlorite having an available chlorine content between 75% and 81%;
(ii) lime, in an amount which results in the shaped article having a total lime content greater than 11% by weight; and
(iii) a hydrated magnesium sulfate in an amount between 25% and 30% by weight of the shaped article;
wherein the shaped article contains at least 17% by weight of water derived from the components of the shaped article, based on the total weight of the shaped article, and the shaped article has a NFPA class 1 oxidizer rating and a non-Division 5.1 rating.

29. The shaped article according to claim 28, wherein the shaped article is a unitary structure formed from a blend of the calcium hypochlorite, the lime, and the hydrated magnesium sulfate.

30. The shaped article according to claim 28, wherein the shaped article comprises layered structure, having at least a first layer and a second layer, the first layer and the second layer each a first surface and opposite second surface, wherein the first surface of the first layer is in contact with the first surface of the second layer, and wherein the first layer comprises a blend of the calcium hypochlorite and the lime; and the second layer comprises the hydrated magnesium sulfate.

31. The shaped article according to claim 30, further comprising a third layer, wherein the third layer has a first surface, wherein the first surface of the third layer is in contact the second surface of the first layer, such that the first layer is between the second and third layers.

32. The shaped article according to claim 31, wherein the first layer has an outer edge and the outer edge is not covered with hydrated magnesium sulfate.

33. The shaped article according to claim 28, wherein the hydrated magnesium sulfate comprises magnesium sulfate tetrahydrate, magnesium sulfate pentahydrate, magnesium sulfate hexahydrate, magnesium sulfate heptahydrate or a combination thereof.

34. The shaped article according to claim 1, wherein the calcium hypochlorite is hydrated.

35. The shaped article according to claim 34, wherein the calcium hypochlorite comprises at least 50% by weight of the shaped article and the lime is present in an amount greater than 11% by weight up to about 20% by weight of the shaped article.

36. The shaped article according to claim 35, wherein—the calcium hypochlorite comprises at least 55 and about 70% by weight of the shaped article and the lime is present in an amount greater than 11% by weight up to about 16% by weight of the shaped article.

37. The shaped article according to claim 1, further comprising an additive.

38. The shaped article according to claim 37, wherein the additive comprises a water-soluble zinc salt, a hydrate of a water-soluble zinc salt, a scale inhibiting agent, a pigment, a dye, a binder, a lubricant, a color-containing salt or a mixture of two or more of these additives.

39. The shaped article according to claim 28, wherein the shaped article is formed from a blend of the calcium hypochlorite, the lime, and the hydrated magnesium sulfate; the calcium hypochlorite is hydrated and has an available chlorine content between about 75% by weight and 85% by weight; the hydrated magnesium sulfate comprises magnesium sulfate tetrahydrate, magnesium sulfate pentahydrate, magnesium sulfate hexahydrate, magnesium sulfate heptahydrate or a combination thereof; and the water content of the blend is between 18% and 28% by weight.

40. The shaped article according to claim 39, wherein the calcium hypochlorite comprises at least 55 and about 70% by weight of the shaped article and the lime is present in an amount greater than 11% by weight up to about 16% by weight of the shaped article.

41. The shaped article according to claim 28, wherein the shaped article is in the form of tablets, bricks, briquettes, pellets, or an extrusion.

42. The shaped article according to claim 39, wherein the shaped article is in the form of tablets, bricks, briquettes, pellets, or an extrusion.

43. The shaped article according to claim 28, having a total weight between 1 and 500 grams.

44. The shaped article according to claim 28, having a dissolution rate such that the shaped article in the form of a tablet dissolves in a range of 3 to 14 days.
